(19) United States
(12) Patent Application Publication
(10) Pub. No.: US 2007/0013658 A1
(43) Pub. Date: Jan. 18, 2007

(54) Wireless indicating apparatus

(76) Inventor: Huan-Wen Chien, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/180,520

(22) Filed: Jul. 14, 2005

(51) Int. Cl. G09G 5/08

(52) U.S. Cl. 345/158

(57) ABSTRACT

A wireless indicating apparatus solves the issues of operating freedom and the inconvenience of wireless input devices of the prior art. The present wireless indicating apparatus records the difference between a horizontal orientation, an operating cursor's position, and the difference between the vertical orientation and the operating cursor's position. Therefore, the user can use the wireless indicating apparatus freely. The wireless indicating apparatus comprises an operating unit, an orientation-sensing unit, a signal-processing unit, a wireless emitting unit and a power supply device. A computer system receives the operation signal via a wireless receiving device and controls the movement, clicking or selection of the cursor upon a screen. Therefore, the operation of the wireless indicating apparatus of the present invention is not limited to a flat surface. It increases the freedom of operation and convenience, and reduces injuries such as those caused by incorrect use of a mouse.

### BACKGROUND OF THE INVENTION

1. Field of the Invention

The present invention relates to a wireless indicating apparatus and in particular, to the operation of a wireless indicating apparatus and system that is not limited to use upon a flat surface and in which the user can use the wireless indicating apparatus by employing hand gestures.

2. Description of Related Art

In order to conveniently operate an electrical apparatus (such as a projecting camera, a PC or a game machine), a user operates the operation system of an electrical apparatus via an input device. The most popular input devices are currently mice, keyboards, handwriting input devices, etc. Because Microsoft Operating Systems are the most popular operating systems, the mouse has become the most common indicating apparatus for most computer users. At the same time, due to the development of wireless communication technology, a lot of wireless input devices (e.g. wireless mice) have been designed and are in use for electrical apparatuses.

Although the development of the mouse has been from a wired mouse to a wireless mouse, a wireless mouse still has to be operated upon a flat surface (e.g. a table, a mouse pad) and must be moved around by the fingers and wrist of the user. When the user operates the mouse for a long time or in an unergonomical manner, the actions will oppress the nerve and cause a wrist-tunnel syndrome. Because some users operate a mouse by leaning their hand against the rim of the table, it will cause “trigeminal nerve” damage. Therefore, there exists some risk of injury from using the mouse. Furthermore the mouse that needs to be operated upon a flat surface limits the freedom of the use of the mouse.

In order to overcome the above issues, some patents are disclosed. Chinese patent TW549491 simply changes the shape of the mouse into a pen-shape. However, the device must still be operated upon a flat surface. Chinese patent TW584286 changes the method of operation of the mouse to a rolling method. The user rolls a rolling wheel via his or her finger. It is inconvenient for the user and requires some time to learn the operation of the mouse. U.S. Pat. No. 6,577,299 needs to be operated upon a flat surface and requires detecting the status of the pen-shaped mouse via an external sensor that transfers the signal.

### SUMMARY OF THE INVENTION

One aspect of the present invention is to give a user greater freedom and convenience when operating a wireless input device than he or she was able to have when using prior art devices. In order to achieve the above objective, the present invention provides a wireless indicating apparatus. The present invention records a difference between a horizontal orientation and an operating cursor position and a difference between a vertical orientation and an operating cursor position. Therefore, the user can use the wireless indicating apparatus freely.

The wireless indicating apparatus of the present invention comprises an operating unit, an orientation-sensing unit, a signal-processing unit, a wireless emitting unit and a power supply device. The power supply device supplies the power for all the units of the wireless indicating apparatus. The user uses the operating unit for inputting instructions. The orientation-sensing unit senses an orientation of the wireless indicating apparatus and transfers the orientation into an orientation signal. The signal-processing unit electrically connects with the operating unit and the orientation-sensing unit. The signal-processing unit receives the orientation signal and transfers it into a position-indicating signal. The wireless emitting unit electrically connects with the signal-processing unit and emits the position-indicating signal to an electrical apparatus. Therefore, the electrical apparatus receives the position-indicating signal via a wireless receiving device and executes the relative operations of position (such as a movement, click or selection of a cursor on a screen).

The orientation-sensing unit comprises a vertical sensing unit and a horizontal sensing unit. The vertical sensing unit is a gravity-sensing unit for sensing the difference between the orientation of the Earth's gravity and the vertical orientation of the wireless indicating apparatus to obtain a vertical orientation. The horizontal sensing unit is a magnetic field sensing unit for sensing the difference between the magnetic field orientation of the Earth and the horizontal orientation of the wireless indicating apparatus to obtain a horizontal orientation. Moreover, the wireless indicating apparatus judges the orientation by utilizing the orientation-sensing unit, and it still can use an orientation basis device to judge the orientation.

The operating unit is an input device and comprises at least one button. For saving power, the wireless indicating apparatus further comprises a power-saving circuit unit. Therefore, the wireless indicating apparatus can enter a power-saving mode when the wireless indicating apparatus is idle for a period of time. Furthermore, the wireless indicating apparatus can further comprise a memory unit for recording a pre-determined mode or a setting mode. The wireless indicating apparatus combines a computer system and a wireless receiving device to form a wireless-indicating system.

Therefore, the operation of the wireless indicating apparatus of the present invention is not limited to use upon a flat surface. It increases the freedom of operation and convenience, and reduces the harm caused by incorrect gestures. Because the user can use the wireless indicating apparatus by any gesture or hand movement, it also reduces the risk of causing injury or harm due to use of the apparatus over a long period. The wireless indicating apparatus is also suitable for a new user as it is easy to learn how to use it and easy to operate.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the wireless indicating apparatus of the present invention;

FIG. 2 is a schematic view of the wireless indicating apparatus of the present invention; and

FIG. 3 is a block diagram of the wireless indicating system of the present invention.

### DETAILED DESCRIPTION OF THE PREFERRED EMBODIMENTS

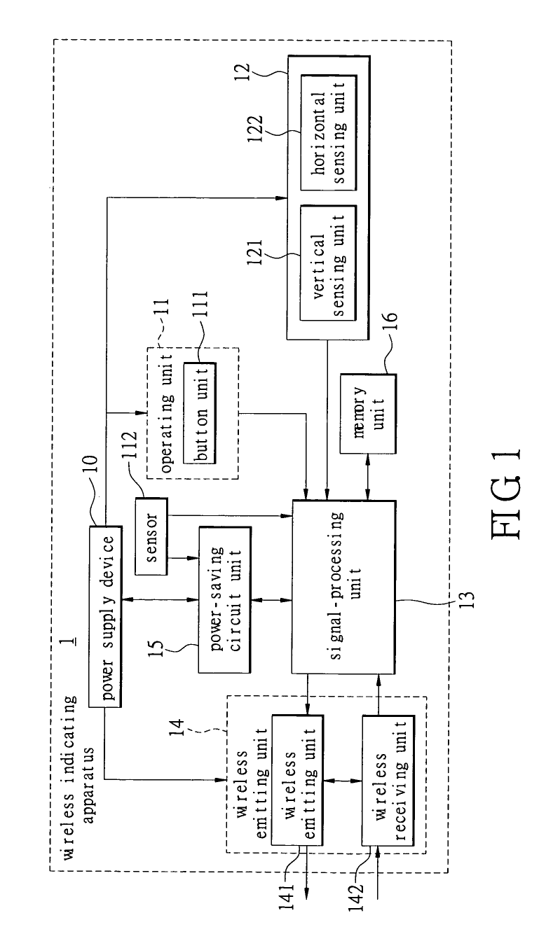

FIG. 1 is a block diagram of the wireless indicating apparatus of the present invention. The wireless indicating apparatus 1 comprises an operating unit 11, an orientation-sensing unit 12, a signal-processing unit 13, a wireless emitting unit 14 and a power supply device 10. The power supply device 10 supplies the power for all units of the wireless indicating apparatus 1. The operating unit 11 is an input device for inputting an instruction by the user. The operating unit 11 includes at least one button unit 111. The orientation-sensing unit 12 is an orientation sensor for sensing or judging the orientation of the wireless indicating apparatus 1. The orientation-sensing unit 12 comprises a vertical sensing unit 121 and a horizontal sensing unit 122. The vertical sensing unit 121 is a gravity-sensing unit for sensing the difference between the orientation of the Earth's gravity and the vertical orientation of the wireless indicating apparatus 1 to obtain a vertical orientation (an angle of elevation). The horizontal sensing unit 122 is a magnetic field sensing unit for sensing the difference between the magnetic field orientation of the Earth and the horizontal orientation of the wireless indicating apparatus 1 to obtain a horizontal orientation.

The signal-processing unit 13 is a signal processor and electrically connects with the operating unit 11 and the orientation-sensing unit 12. The signal-processing unit 13 receives the orientation signal (or an operation signal) and transfers it into a position-indicating signal (or an operation signal of a cursor) via a signal process procedure. The horizontal orientation and the vertical orientation that come from the orientation-sensing unit 12 are used for controlling the movement of the cursor and operating an action on a screen (such as a clicking or selecting operation etc.). The wireless emitting unit 141 electrically connects with the signal-processing unit 13. The wireless emitting unit 141 emits an operation signal of the cursor to a computer system for controlling the action of the cursor on a screen, such as a moving, clicking or selecting operation etc. Moreover, the wireless indicating apparatus 1 judges the orientation by utilizing the orientation-sensing unit 12, it still can use an external orientation basis device to judge the orientation. The external orientation basis device is a computer or a signal generator. The orientation-sensing unit 12 judges and obtains a difference between the external orientation basis device and the indicating orientation of the wireless indicating apparatus 1. Then, the signal-processing unit 13 transfers the difference into a position-indicating signal or an operation signal of the cursor.

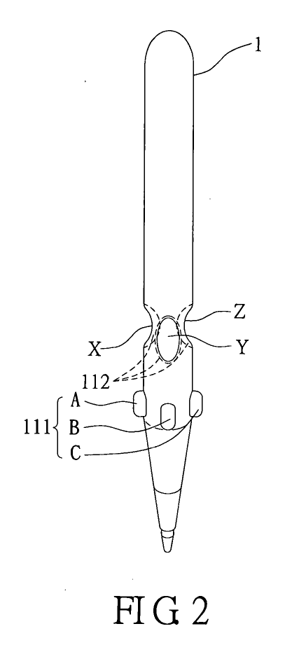

FIG. 2 is a schematic view of the wireless indicating apparatus of the present invention. The design of the wireless indicating apparatus 1 is intuitive. The operating unit 11 of the wireless indicating apparatus 1 includes at least one button 111. The buttons 111 are a button A and a button B. The button A and button B are pressed by a thumb and a forefinger of the user. In the design of the wireless indicating apparatus 1, the operating unit 11 has a notch X and a notch Y. When the user is not pressing the buttons A or B, the user can put their thumb and forefinger on the notch X and notch Y to increase their comfort. Moreover, the operating unit 11 further has a button C and a notch Z to increase the function of the wireless indicating apparatus 1; the notch corresponds to the button C. The user can press the button C by a middle finger and put their finger on the notch Z.

For saving power, the wireless indicating apparatus 1 further comprises a power-saving circuit unit 15. The signal-processing unit 13 detects and judges whether the user has accessed the wireless indicating apparatus 1 within a pre-determined time. When the user has not accessed the wireless indicating apparatus 1 within a pre-determined time, the signal-processing unit 13 informs the power-saving circuit unit 15 to issue a power saving signal to the power supply device 10. The wireless indicating apparatus 1 will then enter a power-saving mode. Moreover, the operating unit 11 has a sensor 112 located at one of the notches X, Y or Z. The sensor 112 electrically connects with the power-saving circuit unit 15. When the sensor 112 detects a pressing action, the wireless indicating apparatus 1 turns on. After the sensor 112 has not detected any signal for a pre-determined time, the power-saving circuit unit 15 issues a signal to make the wireless indicating apparatus 1 enter a power-saving mode. Moreover, the wireless emitting unit 141 combines with a wireless receiving unit 142 to form a wireless communication module 14. The wireless communication module 14 receives a signal from a computer or a signal generator and transmits the signal to the signal-processing unit 13 for judging and processing. The wireless receiving unit 142 is a wireless receiver.

The wireless indicating apparatus 1 can further comprise a memory unit 16 for recording a pre-determined mode or a setting mode set by a user. The pre-determined mode records a relation between the horizontal orientation, the vertical orientation and the position of the cursor. Therefore, the user can directly operate the wireless indicating apparatus 1. On the other hand, the user can enter the setting mode and assign at least two points (e.g. two points located at the two opposite corners of the screen). Then, the signal-processing unit 13 records a horizontal angel and a vertical angel between the two points and treats the horizontal angel and the vertical angel as a boundary and a largest displacement of range of the horizontal angel and vertical angel of the cursor. Finally, the signal-processing unit 13 obtains a transfer relation between the angel and the position (a relation between a position of the cursor on the screen and the horizontal orientation and the vertical orientation of the wireless indicating apparatus 1).

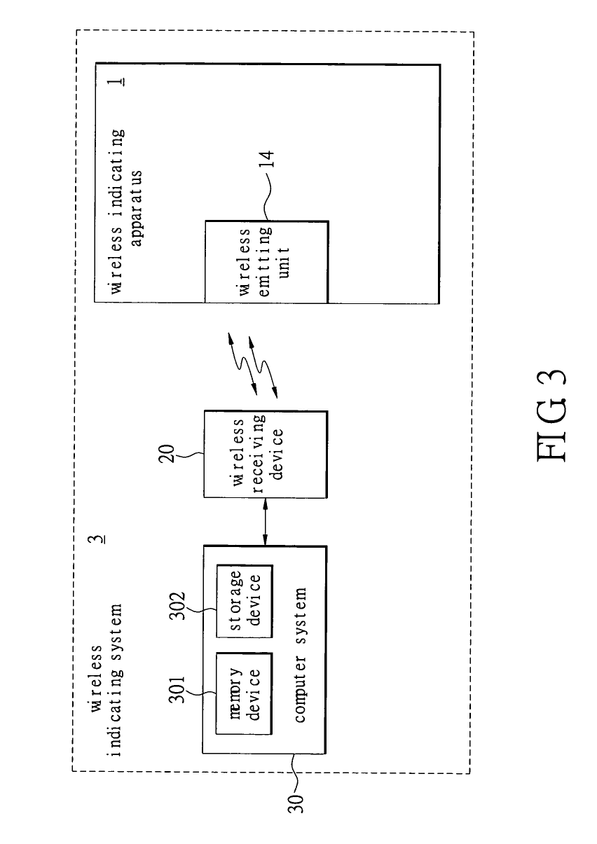

FIG. 3 is a block diagram of the wireless indicating system of the present invention. The wireless indicating apparatus 1 combines a computer system 30 and a wireless receiving device 20 to form a wireless-indicating system 3. The computer system 30 further comprises a memory device 301 or a storage device 302 for recording a pre-determined mode or a setting mode set by a user. When a user operates an electrical device, such as a computer, a game machine or a projecting camera, the user can set the setting mode to make the operation of the wireless indicating apparatus 1 match the position of the cursor. The cursor follows the indicating position of the wireless indicating apparatus 1—an intuition operation. Of course, the user can assign two points to be the judgment points, so the wireless indicating apparatus 1 does not need to be moved upon the screen. In this way, operation of the indicating apparatus is more convenient for the user.

The wireless indicating apparatus 1 can be a handwriting apparatus. The buttons A, B and C (or notches X, Y, and Z) are the locations for the thumb, forefinger, and middle finger for handwriting. When part or all of the buttons A, B and C (or notches X, Y and Z) are pressed, the signal-processing unit 13 judges the operation mode and enters a handwriting mode. The signal-processing unit 13 starts a corresponding handwriting program in the computer system 30 via the wireless emitting unit 141. Moreover, when writing, the thumb, forefinger, and/or middle finger press the button to make the apparatus output every stroke of a character. So, the operation of the buttons A, B and C (or notches X, Y and Z) represents every stroke of a letter or character. For example, pressing initially the buttons A, B and C (or notches X, Y and Z) means an initial orientation of the stroke of the character, the orientation variation of the pressing process means the shape of the strokes of the character, releasing the buttons A, B and C (or notches X, Y and Z) means an ending orientation of the stroke of the character, etc. Combining these operations results in inputted character. The wireless indicating apparatus 1 can also be an operation device for a game machine by utilizing the wireless indicating apparatus 1. The wireless indicating apparatus 1 can also be applied to other consumer electrical apparatuses by installing the wireless indicating apparatus 1 in other devices (such as installing the wireless indicating apparatus 1 in a game machine gun).

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A wireless indicating apparatus, comprising:
a power supply device, for supplying the power for all units of the wireless indicating apparatus;
an operating unit, for providing a user to input an instruction;
an orientation-sensing unit, for sensing an orientation of the wireless indicating apparatus and transferring the orientation into an orientation signal;
a signal-processing unit, electrically connecting with the operating unit and the orientation-sensing unit, for receiving the orientation signal and transferring the orientation signal into a position-indicating signal; and
a wireless emitting unit, electrically connecting with the signal-processing unit, emitting the position-indicating signal to an electrical apparatus.

2. The wireless indicating apparatus of claim 1, wherein the operating unit comprises at least one button.

3. The wireless indicating apparatus of claim 1, wherein the orientation-sensing unit comprises:
a vertical sensing unit, sensing an elevation angle of the wireless indicating apparatus; and
a horizontal sensing unit, sensing a horizontal orientation of the wireless indicating apparatus.

4. The wireless indicating apparatus of claim 3, wherein the horizontal sensing unit is a magnetic field sensing unit, and the signal-processing unit amends the horizontal orientation of the wireless indicating apparatus with the horizontal component of the Earth's magnetic field.

5. The wireless indicating apparatus of claim 3, wherein the vertical sensing unit is a gravity-sensing unit.

6. The wireless indicating apparatus of claim 1, further comprising an orientation basis device that senses an orientation of the orientation basis device and transfers the orientation of the orientation basis device into an orientation signal.

7. The wireless indicating apparatus of claim 1, further comprising a power-saving circuit unit that detects when the wireless indicating apparatus has not been used within a pre-determined time and issues a power saving signal to the power supply device to make the wireless indicating apparatus enter a power-saving mode.

8. The wireless indicating apparatus of claim 7, further comprising a sensor, wherein the sensor electrically connects with the power-saving circuit unit, when the sensor detects a pressing action from the user, the sensor issues a sensing signal to the power-saving circuit unit, the power-saving circuit unit receives the sensing signal and turns on the wireless indicating apparatus.

9. The wireless indicating apparatus of claim 8, wherein the wireless indicating apparatus has at least one notch formed on the shell, the sensor is located in the notch.

10. The wireless indicating apparatus of claim 9, wherein the wireless indicating apparatus enters a handwriting mode when the at least one notch or the at least one button is pressed.

11. The wireless indicating apparatus of claim 10, wherein the wireless indicating apparatus obtains strokes of a character by checking whether the at least one notch or the at least one button has been pressed when operated on the handwriting mode.

12. The wireless indicating apparatus of claim 1, further comprising a wireless receiver, for receiving a signal from the electrical apparatus.

13. The wireless indicating apparatus of claim 1, further comprising a memory unit, wherein the memory unit electrically connects with the signal-processing unit and records a pre-determined mode or a setting mode, and the signal-processing unit transfers the orientation signal into a position indicating signal via the pre-determined mode or the setting mode.

14. The wireless indicating apparatus of claim 13, wherein the pre-determined mode records a transfer relation between the horizontal orientation and the vertical orientation of the wireless indicating apparatus and the indicating position.

15. The wireless indicating apparatus of claim 13, wherein the orientation-sensing unit senses at least two orientation points of the wireless indicating apparatus when operated on the setting mode, and the signal-processing unit transfers the two orientation points and stores them in the memory unit.

16. A wireless indicating system, comprising:
a computer system with a wireless receiving unit, receiving an operation signal of a cursor from a wireless indicating apparatus, for controlling the cursor in a screen;
wherein the wireless indicating apparatus comprising:
a power supply device, for supplying the power for all units of the wireless indicating apparatus;
an operating unit, for providing a user to input an instruction;
an orientation-sensing unit, for sensing an orientation of the wireless indicating apparatus and transferring the orientation into an orientation signal;
a signal-processing unit, electrically connecting with the operating unit and the orientation-sensing unit, for receiving the orientation signal and transferring the orientation signal into a position-indicating signal; and
a wireless emitting unit, electrically connecting with the signal-processing unit, for emitting the position-indicating signal to an electrical apparatus.

17. The wireless indicating system of claim 16, wherein the orientation-sensing unit comprises:
a vertical sensing unit, for sensing an elevation angle of the wireless indicating apparatus; and
a horizontal sensing unit, for sensing a horizontal orientation of the wireless indicating apparatus.

18. The wireless indicating system of claim 16, further comprising a power-saving circuit unit, that detects when the wireless indicating apparatus has not been used for a pre-determined time and issues a power saving signal to the power supply device to make the wireless indicating apparatus enter a power-saving mode.

19. The wireless indicating system of claim 16, further comprising a sensor, wherein the sensor electrically connects with the power-saving circuit unit, when the sensor detects a pressing action by the user, the sensor issues a sensing signal to the power-saving circuit unit, the power-saving circuit unit receives the sensing signal and turns on the wireless indicating apparatus.

20. The wireless indicating system of claim 16, further comprising a memory unit, wherein the memory unit electrically connects with the signal-processing unit, and records a pre-determined mode or a setting mode, and the signal-processing unit transfers the orientation signal into a position indicating signal via the pre-determined mode or the setting mode.
